(19) United States
(12) Patent Application Publication
(10) Pub. No.: US 2014/0310936 A1
(43) Pub. Date: Oct. 23, 2014

(54) UNIVERSAL PULLER AND INSTALLER TOOL

(71) Applicant: Scott Manno, Fairview Heights, IL (US)

(72) Inventor: Scott Manno, Fairview Heights, IL (US)

(21) Appl. No.: 13/867,043

(22) Filed: Apr. 20, 2013

(51) Int. Cl. B25B 27/02; B25B 28/00

(52) U.S. Cl. CPC B25B 27/026; B25B 28/00
USPC 29/426.5; 29/252

(57) ABSTRACT

A pneumatically operated tool (10) has a piston (44) whose movement is controlled by a user operated handle (32) which controls air flow to reciprocate the piston through a housing (12). Accessories (70, 80) attachable to one end of the tool are used to remove gears, pulleys and axels, these operations being controlled by the user's movement of the handle.

### CROSS-REFERENCE TO RELATED APPLICATIONS

This Non-Provisional application claims priority to U.S. Provisional Application Ser. No. 61/635,438 filed Apr. 19, 2012, and which is incorporated herein by reference.

### STATEMENT REGARDING FEDERALLY SPONSORED RESEARCH

Not Applicable.

### BACKGROUND OF THE INVENTION

This invention relates to a pneumatically operated tool; and, more particularly to a universal tool for removing gears, pulleys, shafts, and axels.

In many industrial applications, it is often necessary to replace a worn or damaged part and replace it with a new part. Often the part that needs removal and replacing is a gear or a pulley, or a shaft or an axel. Although tools have been heretofore available to help accomplish this task, usually a tool that can be used to replace and install one of these parts cannot be used to replace and install another. This leads to a profusion of tools being required, each of which needs to be kept on hand for ready use. This, of course, adds to the cost of maintaining an adequate number of instruments to do the job and the time required for each operation while the appropriate tool is located.

### BRIEF SUMMARY OF THE INVENTION

The present invention is directed to a pneumatically operated tool which can be used, with the appropriate accessory to remove and install a wide variety of equipment parts. As such, the tool is a universal tool that reduces the number of tools required for equipment maintenance and repair. Further, the accessories which are used with the tool are easy to store, install, and use. This further reduces equipment cost, as well as the time required for performing equipment maintenance and repair.

### BRIEF DESCRIPTION OF THE SEVERAL VIEWS OF THE DRAWINGS

In the accompanying drawings which form part of the specification:

FIG. 1 is a sectional view of a pneumatically operated tool of the present invention;

FIGS. 2A and 2B are respective top and bottom views of a cap piece of the tool;

FIG. 3 is a top view of a piston of the tool;

FIG. 4 is a plan view of one attachment for use with axels and some gears and pulleys;

FIGS. 5A and 5B are respective top and side views of another attachment for use in pulling gears and pulleys; and

FIG. 6 is a sectional view of an alternate embodiment of a pneumatically operated tool of the present invention.

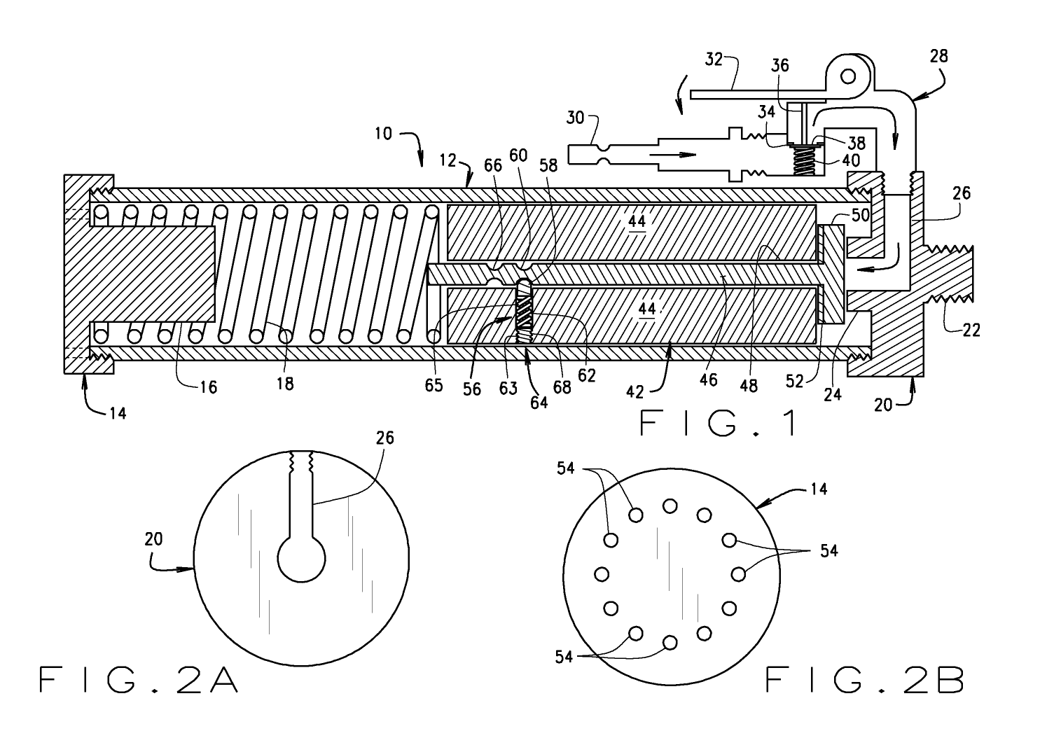

Corresponding reference numerals indicate corresponding parts throughout the several figures of the drawings.

### DETAILED DESCRIPTION OF INVENTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

Referring to the drawings, a pneumatically operated tool of the present invention is indicated generally 10. The tool 10, which is available in a variety of sizes, comprises a cylindrical housing 12 which is threaded at each end and. The housing 12 defines a bore 11 configured for receipt of a piston assembly 13. On one end of the housing 12, a cap 14 is installed, the cap 14 having an anvil 16 which extends partway along the interior of the housing 12. A coil spring 18 is fitted about the anvil 16 with one end of the spring 18 seated against the inside of cap 14.

A puller attachment 20 is threaded onto the other end of the housing 12. A threaded boss 22 projects outwardly from the center of attachment 20 for various accessories to be connected to the tool 10. A hollow boss 24 formed on the inside of attachment 20 extends into the interior of housing 12 from the other end of the housing 12. An L-shaped air passage 26 extends from boss 24 to a threaded air inlet 26 formed in a sidewall of attachment 20.

A handle assembly 28 is threaded onto inlet 26. The handle 28 is hollow, and a nipple 30 on the opposite end of the handle 28 is attached to a source of pressurized air (not shown). A handle 32 is rotatably connected to assembly 28 and when pressed downwardly as indicated by the arrow in FIG. 1 opens a valve 34 within the assembly 28. One end of a shaft 36 is attached to handle 32 and the other end of the shaft 36 to a valve member 38. A coil spring 40 biases member 38 to close valve 34. When handle 32 is depressed as indicated by the arrow, valve member 38 is moved against the force of spring 40 to open valve 34.

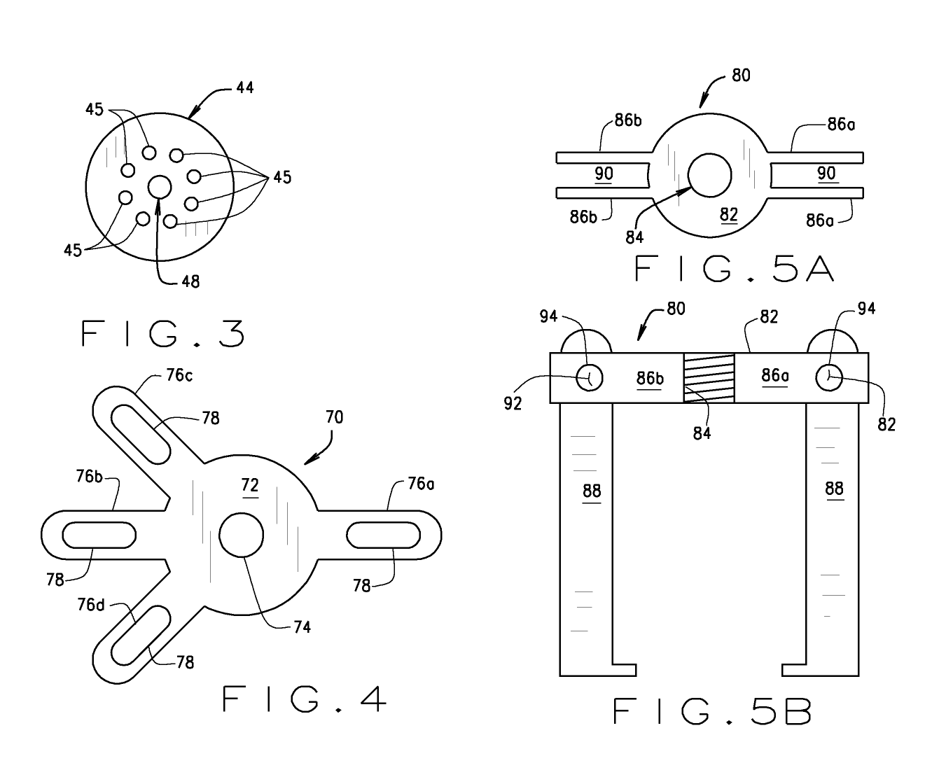

With valve 34 open, pressurized air flows through assembly 28 and passage 26 to press against one end of a piston assembly 42. Assembly 42 includes a cylindrically shaped piston 44 reciprocal in housing 12. As shown in FIG. 3, piston 44 has a series of circumferentially spaced longitudinally extending holes 45 formed in it. An air valve shaft 46 extends through a central bore 48 formed in piston 44. The air valve shaft 46 is generally T-shaped with a head 50 being formed on the outer end of shaft 46 and seated against the upper end of piston 44. A seal 52 is interposed between head 50 of valve 46 and the abutting face of piston 44. When valve 34 is open pressurized air presses against the head 50 to move piston 44 down onto anvil 16 of end cap 14 against the force of spring 18.

End cap 14 has a series of circumferentially spaced vent holes 54 formed in it. As piston 44 moves down onto anvil 16, any air within housing 12 is expelled through these openings. When the piston 44 reaches the end of its travel, handle 32 is released and the force of spring 18 restores the piston 44 back to its initial position. Accordingly, piston 44 does not reciprocate automatically, but is controlled by the user's operation of handle 32 to open and close valve 34.

Air pressure within housing 12 is controlled by a ball check valve assembly 56. This assembly 56 includes a ball 58 seated in a detent or circumferential groove 60 formed in shaft 46. The ball 58 is held in place by a spring 62 and a spacer 63. The ball 58 and spring 62 are installed in a radial bore 65 in piston 44 which extends between the inner wall of housing 12 and shaft 46. If air pressure becomes too great within housing 12, it unseats ball 58 from its seat allowing piston 44 to move along the shaft 46. A second detent or circumferential groove 66 is formed in shaft 46 downstream of groove 60. When piston 44 moves a distance sufficient that groove 66 is now adjacent the check valve assembly 56, spring 62 pushes ball 58 into groove 66 to stop movement of the piston 44. The air pressure at which the ball check valve assembly 56 operates is controlled by the force of spring 62.

FIGS. 4, 5A and 5B illustrate accessories or attachments used with tool 10. An accessory 70 shown in FIG. 4 comprises an adjustable puller for pulling axels, pulleys, and certain types of gears. The accessory 70 has a circular main body 72 with a central threaded bore 74. The accessory 70 is mounted to the tool 10 by screwing the tool 10 onto threaded boss 22 of the tool 10. The accessory 70 includes opposed fingers 76a, 76b projecting outwardly from body 72. In addition, the accessory 70 also has a pair of fingers 76c and 76d which extend outwardly of body 72 at about 45° angles on either side of finger 76b. Each finger 76a, 76b, 76c, and 76d has a hollow slot 78 formed in it. The slots 78 each have rounded ends and extend longitudinally of their respective finger 76a, 76b, 76c, or 76d.

In FIGS. 5A and 5B, as second embodiment of an accessory, a gear and pulley puller 80 has a circular main body 82 with a central threaded bore 84. Again, the accessory 80 is mounted to tool 10 by screwing the tool 10 onto threaded boss 22 of the tool 10. The puller 80 includes opposed bifurcated fingers 86a, 86b which project outwardly from body 82. A jaw member 88 fits into a slot 90 formed in each finger 86a, 86b. The jaws 88 are each attached to its associated finger 86a, 86b by a screw 92 which is threaded into a threaded bore 94 formed on the sides of the respective fingers 86a, 86b. At the lower end of each jaw 88 is a flange 96 which extends at a right angle to the vertical section of the jaw 88 as shown in FIG. 5B. Depending upon the particular application, the jaws 88 are installed in accessory 80 so the flanges 96 face inwardly, as shown in drawing, or outwardly.

In operation, piston 44 does reciprocate automatically when the user depresses handles 32. Rather, when the handle 32 is pushed, piston 44 moves through housing 12 until it strikes anvil 16. The handle 32 is then released with the piston 44 being returned back to its original position by the force of spring 18. This action is repeated until the removal operation is completed, this mode of operation giving the user great control over the removal operation.

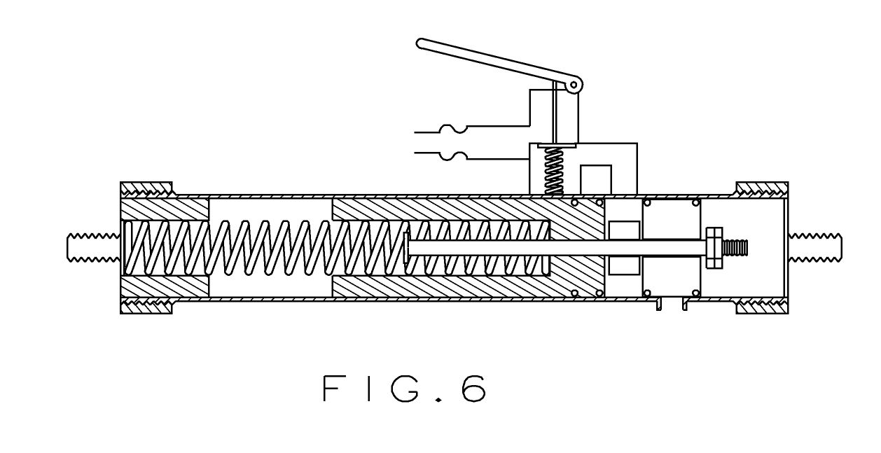

FIG. 6 shows an alternate embodiment of a pneumatically operated tool of the present invention is indicated generally 100.

Changes can be made in the above constructions without departing from the scope of the invention, it is intended that all matter contained in the above description or shown in the accompanying drawings shall be interpreted as illustrative and not in a limiting sense.

What is claimed is:

1. A pneumatically operated tool, comprising:
a housing defining a bore;
a piston assembly operatively positioned within the bore for reciprocal movement;
a puller attachment connected to an end of the housing and configured for mating with an accessory; and
a handle assembly operatively connected to the piston assembly and configured for detachable connection to a source of air pressure for control of the flow of air pressure to the piston assembly for reciprocal movement of the piston assembly.

2. The pneumatically operated tool of claim 1, the piston assembly comprising:
an anvil positioned at a first end of the housing within the bore;
a spring seated about the anvil at a first end of the housing within the bore; and
a piston moveably positioned within the bore.

3. The pneumatically operated tool of claim 2, the piston assembly further comprising a ball check assembly.

4. The pneumatically operated tool of claim 2, wherein the piston defines generally longitudinal holes.

5. The pneumatically operated tool of claim 1, wherein an end of the housing defines vent holes.

6. The pneumatically operated tool of claim 1, the accessory comprising a generally circular body defining a bore adapted for engagement with the puller attachment, the body having opposed fingers extending outwardly from the body.

7. The pneumatically operated tool of claim 1, the accessory comprising:
a generally circular body defining a bore adapted for engagement with the puller attachment, the body having opposed bifurcated fingers extending outwardly from the body; and
a jaw member attached to each bifurcated finger and extending generally at a right angle relative to respective fingers.

8. The pneumatically operated tool of claim 1, the handle assembly comprising:
a nipple for detachable connection to the source of air pressure;
a handle operatively connected to the nipple;
a valve member operatively connected to the handle for movement of the valve member between an open position for communication of air pressure to the piston assembly, to a closed position that prevents communication of air pressure to the piston assembly; and
a spring operatively connected to the valve member to bias the valve member to the closed position.

9. A pneumatic system for removal of parts, comprising:
a housing;
a piston assembly operatively positioned within the housing for reciprocal movement;
a puller attachment detachably connected to an end of the housing and configured for mating with multiple accessories; and
a handle assembly operatively connected to the piston assembly and configured for detachable connection to a source of air pressure for control of the flow of air pressure to the piston assembly for reciprocal movement of the piston assembly.

10. The pneumatic system of claim 9, the piston assembly comprising:
an anvil positioned at a first end of the housing within the bore;
a spring seated about the anvil at a first end of the housing within the bore; and
a piston moveably positioned within the bore.

11. The pneumatic system of claim 10, the piston assembly further comprising a ball check assembly.

12. The pneumatic system of claim 10, wherein the piston defines generally longitudinal holes.

13. The pneumatic system of claim 9, wherein an end of the housing defines vent holes.

14. The pneumatic system of claim 9, the accessory comprising a generally circular body defining a bore adapted for engagement with the puller attachment, the body having opposed fingers extending outwardly from the body.

15. The pneumatic system of claim 9, the accessory comprising:
a generally circular body defining a bore adapted for engagement with the puller attachment, the body having opposed bifurcated fingers extending outwardly from the body; and
a jaw member attached to each bifurcated finger and extending generally at a right angle relative to respective fingers.

16. The pneumatic system of claim 9, the handle assembly comprising:
a nipple for detachable connection to the source of air pressure;
a handle operatively connected to the nipple;
a valve member operatively connected to the handle for movement of the valve member between an open position for communication of air pressure to the piston assembly, to a closed position that prevents communication of air pressure to the piston assembly; and
a spring operatively connected to the valve member to bias the valve member to the closed position.

17. A method for removal of parts, comprising the steps of:
providing a housing defining a bore;
providing a piston assembly operatively positioned within the bore for reciprocal movement;
providing a puller attachment connected to an end of the housing and configured for mating with an accessory; and
providing a handle assembly operatively connected to the piston assembly and configured for detachable connection to a source of air pressure for control of the flow of air pressure to the piston assembly for reciprocal movement of the piston assembly;
connecting the source of air pressure to the handle assembly; and
depressing the handle assembly to communicate a flow of air pressure to the piston assembly for reciprocal movement of the piston assembly.
